(19) United States
(12) Patent Application Publication
(10) Pub. No.: US 2008/0115071 A1
(43) Pub. Date: May 15, 2008

(54) System And Methods For Zero-Configuration Data Backup

(76) Inventor: Thomas T. Fair, Charleston, SC (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/875,238

(22) Filed: Oct. 19, 2007

Related U.S. Application Data
(60) Provisional application No. 60/862,095, filed on Oct. 19, 2006.

(51) Int. Cl. G06F 17/30; G06F 3/048

(52) U.S. Cl. 715/764; 707/204; 715/700; 707/E17.005

(57) ABSTRACT

Methods, systems, and apparatuses used for backing up data stored on a source, comprising connecting a backup device to the source, the backup device having a backup application stored therein, launching the backup application from the backup device without user installation of the backup application, identifying the operating system and data storage structure of the source to the backup application, retrieving a pre-configured list associated with the identified operating system and data storage structure wherein the pre-configured list identifies data storage locations for data stored on the source, and copying data from the identified data storage locations on the source to pre-defined data storage locations on the backup device. Previously backed up data stored on the backup device is easily copied back onto the source for restoration purposes merely by reconnecting the backup device to the source or easily transferred to another source merely by connecting to the second source.

### CROSS-REFERENCE TO RELATED APPLICATIONS

This application claims the benefit under 35 U.S.C. §119(e) of U.S. provisional patent application No. 60/862,095, entitled “Plug & Play Data Backup System and Device a/k/a Zero-Configuration Data Backup,” filed Oct. 19, 2006, which is incorporated herein by reference in its entirety.

### THE FIELD OF INVENTION

The present invention relates generally to data management and storage solutions and, more particularly, to improved systems and methods for automatic data backup without the need for an end user to install, program, or otherwise configure the backup process.

### BACKGROUND OF THE INVENTION

The most important asset of many businesses is data, which includes user-created information, computer- and device-created information, information imported from outside sources, and settings and preferences stored within the computer or computerized device. The majority of business data in the twenty-first century is stored on computers and computerized devices. Data comes in many forms and formats and is stored or organized in many different ways. That data, however, is subject to loss, due to many hazards such as data corruption, hardware failure, human error, theft, or software attacks.

The single most important defense against data loss is an effective data backup, the copying of stored data to a medium that would remain intact in the case of damage, corruption, or loss to the original data. An effective backup protects all of the user's data and allows a business or individual to completely recover the original data after a catastrophic loss or error. Most small businesses and individual computer users do not effectively back up data as a standard practice. Typical data backup systems are inefficient, time consuming, and only sporadically used, due to their complexity. Yet the majority of businesses and individuals have a monetary interest in protecting critical data such as customer lists, vendor lists, tax information, contracts, proprietary documents, and other historical documents or records.

One of the main reasons small businesses and individuals do not back up data is because of complexity. The selection, installation, and configuration of most data backup systems requires a high degree of expertise and experience. Hiring consultants with such knowledge is expensive; attempting to set up a backup system without such knowledge is daunting and very often results in a faulty backup system. Selecting and installing backup hardware involves choosing a data storage technology, which can be a difficult task even for computer professionals. Even after choosing the technology, the user will likely sort through numerous hardware brands and models in search of a storage device with suitable media type, capacity, speed, compression ratio, and other options. After the hardware is selected, a similar process is required to find appropriate software that works with the chosen hardware. The user is then faced with the task of installing the hardware and software, then programming the software to create an effective backup—one that protects all of the user's data. In the case of most backup systems, this is a very difficult task.

Another substantive task involves determining what to back up. This task is compounded by determining where data is located. For example, the average Microsoft Windows-based computer system contains well over 100,000 files. Only a small percentage of these files are user files that need to be backed up or restored. User files are stored in disparate file locations on Windows computers. In some instances, these files are located in hidden folders, invisible to most users. Finding these files is a non-trivial task for the end user. The task of ensuring that all critical files are backed up relies upon user intervention. The result is a large investment of time and often an incomplete backup. Another issue to consider when backing up critical data is the back up schedule. IT professionals traditionally create back up “jobs” while defining numerous configurable options. After defining those options, each job can be scheduled to ensure proper backup of data. This is yet another daunting task for small businesses or individual users that do not have their own IT department or access to an IT professional.

In addition to the complexities of backing up data described above, decentralized data complicates the matter of backing up data effectively. Data backup systems for personal computers (PCs) and PC-based servers were developed during the 1980s and 1990s, when most small businesses and individuals had one computer at most. Larger companies stored most of their data on one or more servers. In all of these cases, critical data could be protected by backing up a single computer or a few servers. Accordingly, backup systems were designed to back up a single fixed computer.

Early in the twenty-first century, however, new innovations began to change the way that businesses and individuals stored data. Improved computer technologies, including miniaturization and specialization, allowed the creation of a wide variety of computerized devices, such as cell phones, PDAs, mobile devices, etc. Such computerized devices consist of different file systems, file formats, connections, and operating systems. Perhaps the most profound change was the mobility of these devices. For the most part, they were not attached to a network system. They were found in cars, pockets, backpacks, and living rooms, and more particularly, there was not an effective means to protect the growing quantity of data stored in them.

Traditional backup solutions do not address the data protection challenges presented by these new technologies. Users are still required to make numerous crucial installation, configuration and data management decisions. But now, they must make these decisions for every computer and computerized device they use. The potential for errors and the potential for unrecoverable data loss is greater now than it has ever been before. For these reasons, there is a need for systems and methods that provide a pre-configured backup and restore system.

### SUMMARY OF THE PRESENT INVENTION

A first aspect of the present invention relates to backing up data stored on a source and includes a method comprising the steps of connecting a backup device to the source, the backup device having a backup application stored therein, launching the backup application from the backup device without user installation of the backup application, identifying the operating system and data storage structure of the source to the backup application, retrieving a pre-configured list associated with the identified operating system and data storage structure wherein the pre-configured list identifies data storage locations for data stored on the source, and copying data from the identified data storage locations on the source to pre-defined data storage locations on the backup device.

In a feature of the first aspect of the present invention, the step of copying data includes implementing pre-defined options programmed into the backup application. Typically, the pre-defined options include one of data compression, data encryption, data overwrite, data synchronization, and scheduled time for initiating the step of copying.

In another feature, the method includes the additional step of obtaining user authorization before the step of launching the backup application.

In yet another feature, the step of copying data includes implementing user-defined options selected by a user of the source and wherein the user-defined options are stored on the backup device.

In another feature, the pre-defined data locations on the backup device mirror the identified data storage locations on the source. In another feature, pre-defined data locations on the backup device may include a single storage location that is indexed according to the pre-defined data locations on the backup device. In another feature, the backup device stores data in a Redundant Array of Independent Disks (RAID) configuration.

In other various features, the method includes the step of displaying a user interface to a user of the source. Typically, the user interface is displayed on a display associated with the source or associated with the backup device. Further, the method includes the step of enabling a user of the source to identify user-defined data storage locations on the source and wherein the step of copying further comprises copying data from the user-defined data storage locations on the source to the backup device.

Another feature includes the step of restoring previously copied data back from the backup device to the identified data storage locations on the source.

In further features, the method includes the step of transferring previously copied data from the backup device to the identified data storage locations on a different source. Preferably, the backup device is configured for use with a plurality of sources and users and further comprising the step of identifying the source and user of the source after connecting the backup device to the source. Typically, the source is one of a computer, a server, a PDA, an external computer drive, a portable data collector, a handheld data storage device, a phone, a camera, a global positioning system device, a formatted media player, an embedded data storage device in another machine or another device.

In another feature, the method includes the step of encrypting or compressing the data copied to the backup device.

Typically, the backup device is connected to the source using a wired or a wireless connection.

In yet another feature, the method includes the step of launching the backup application is accomplished using autorun functionality associated with the operating system of the source when the backup device is connected to the source. Preferably, the step of launching the backup application is accomplished by the operating system of the source after receiving approval from a user of the source.

In other features, the backup application is launched manually by a user of the source. In one embodiment, the backup application is launched automatically and periodically according to a backup schedule.

In another feature, the pre-configured list is retrieved by the backup application from a database on the backup device. In one embodiment, the pre-configured list is retrieved by the backup application from a database accessed through the source. In another embodiment, the pre-configured list is retrieved by the backup application from a database accessed over the Internet.

A second aspect of the present invention relates to restoring data to a source, a method comprising the steps of connecting a backup device to the source, the backup device having a backup application stored therein, launching and running the backup application from the backup device without user installation of the backup application, identifying data on the backup device associated with a previous backup of data from data storage locations on the source, displaying a user interface to a user of the source, wherein the user interface is adapted to display the identified data stored on the backup device and its associated data storage location, and copying selected data from the identified data stored on the backup device to the corresponding data storage locations on the source.

In a feature of the second aspect of the present invention, the display of the identified data and corresponding data locations is presented in a collapsible, hierarchical file and folder format.

In another feature, the method includes the step of prompting the user before the copying of selected data if there is a filename conflict between data being stored on the backup device and the source.

In yet another feature, the method includes step of identifying data on the backup device comprises identifying data associated with more than one previous backup of data on the backup device and wherein the step of displaying displays the more than one previous backup to the user.

In another feature, the step of copying selected data comprises enabling the user to select from between at least two different sets of data previously stored on the backup device.

A third aspect of the present invention relates to transferring data from a first source to a second source, and a method comprising the steps of connecting a backup device to the first source, the backup device having a backup application stored therein, launching the backup application from the backup device without user installation of the backup application on the first source, identifying the operating system and data storage structure of the first source to the backup application, retrieving a pre-configured list associated with the identified operating system and data storage structure of the first source wherein the pre-configured list identifies data storage locations for data stored on the first source, copying data from the identified data storage locations on the first source to the backup device, and thereafter, comprising the steps of connecting the backup device to the second source, launching the backup application from the backup device without user installation of the backup application on the second source, displaying a user interface to a user of the second source, wherein the user interface is adapted to display a listing of data copied to the backup device from the first source, and selectively copying data identified in the listing of data to corresponding data storage locations on the second source.

In a feature of the third aspect of the present invention, the method includes the step of identifying the operating system of the second source to the backup application after connecting the backup device to the second source. The method further includes the step of identifying data storage locations on the second source associated with the operating system of the second source. Typically, the operating system of the second source differs from the operating system of the first source. Further the method includes the step of using a pre-programmed data map to determine the data storage locations on the second source that correspond with the data storage locations of the first source.

In another feature of the third aspect of the present invention, the step of selectively copying data to selected data storage locations on the second source comprises overwriting data previously stored on the second source. In one embodiment, selectively copying data to selected data storage locations on the second source comprises, if there is a filename conflict between data being copied to the second source and data pre-existing on the second source, creating a new storage location on the second source for receiving the data being copied. In another embodiment, selectively copying data to selected data storage locations on the second source comprises, if there is a filename conflict between data being copied to the second source and data pre-existing on the second source, overwriting data previously stored on the second source only if the data being copied from the backup device has a more recent file date. In yet another embodiment, selectively copying data to selected data storage locations on the second source comprises, if there is a filename conflict between data being copied to the second source and data pre-existing on the second source, prompting a user of the second source to decide whether to overwrite data previously stored on the second source.

The present invention also encompasses computer-readable media having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 illustrates schematically a high level, component view of a zero-configuration and zero-installation data backup system for facilitating a backup and a restore of data, in accordance with an exemplary embodiment of the present invention;

FIG. 2 illustrates a software/hardware block diagram depicting the system of FIG. 1, in accordance with the present invention, containing examples of data from a Microsoft Windows-based computer;

FIG. 3 illustrates an example of a Backup Page that is displayed to a user of the system of FIG. 1;

FIG. 4 shows an example of a View and Restore Page that is displayed to a user of the system of FIG. 1;

FIG. 5 shows an example of a Transfer Page that is displayed to a user of the system of FIG. 1;

FIG. 6 shows an example of a What to Back Up Page that is displayed to a user of the system of FIG. 1;

FIG. 7 shows an example of an Options Page that is displayed to a user of the system of FIG. 1;

FIG. 8 shows an example of an Update Page that is displayed to a user of the system of FIG. 1;

FIG. 9 shows an example of a Schedule Backups Page that is displayed to a user of the system of FIG. 1;

FIG. 10 illustrates a high level flow chart of a methodology performed according to the present invention;

FIG. 11 illustrates a logic flow diagram of steps performed according to the present invention;

FIG. 12 illustrates another logic flow diagram of steps performed according to the present invention; and

FIG. 13 illustrates a flow chart of steps performed according to the present invention.

### DETAILED DESCRIPTION OF THE EMBODIMENTS

Reference is now made in detail to the description of the embodiments as illustrated in the drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

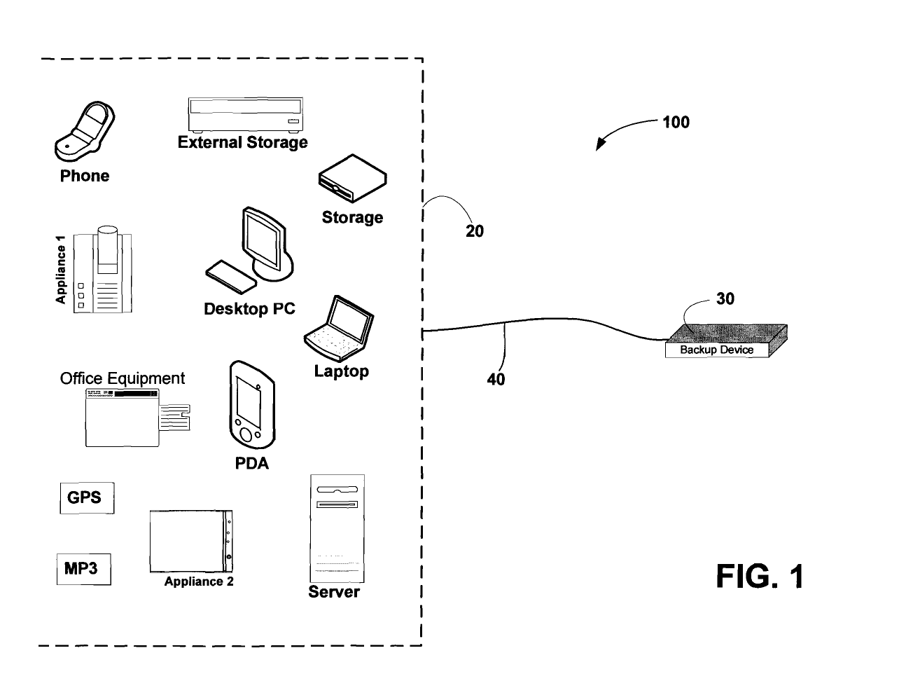

Turning attention now to the drawings, FIG. 1 illustrates a high level, component view of an exemplary Zero-Configuration Backup system 100 for facilitating a backup and a restore of data stored on one or more computers or computerized devices. The system 100 includes a “source” 20 that has data that needs to be backed up and a primary, zero-configuration backup device 30 that, when coupled to the source 20 using a suitable wired or wireless connection 40, is configured to back up data stored on the source 20, to restore data back into the source 20 based on a prior backup of such device, or to transfer data, using the backup device 30, from one source to another or to a different storage device.

The source 20 can actually be any type of device that stores data and that is capable of coupling with or communicating with the backup device 30. For example, the source 20 can be a computer such as a desktop, laptop, notebook or server. Other valid types of sources 20 include external computer drives, such as hard drives, optical drives, flash memory drives, and other storage technologies. Additionally, the source 20 can be a personal digital assistant, global positioning system, portable data collector, or any other handheld computer or device that stores data. Also, the source 20 can be a mobile phone, a camera, or a formatted media player, all of which include data storage capability. Other potential sources include embedded data storage devices, such as those found in automobiles, airplanes, boats, ships, computerized tools, computerized equipment, telephone systems and other appliances. Further, the source 20 may be a host of other devices 20 that use memory to store user data and settings including tools, alarm systems, musical instruments, computer peripherals, entertainment systems, and biometric identification systems. Basically, as used herein, the source 20 includes any device that uses storage area or memory to store data, settings, or preferences. The connection 40 provides a medium for data transfer and communication between the source 20 and the backup device 30, using any wired or wireless communication protocol, format and connection type. Such protocols, formats, and connection types include but are not limited to a Universal Serial Bus, IEEE 1394, Small Computer System Interface (SCSI), Personal Computer Memory Card International Association (PCMCIA) or Personal Computer (PC) card devices such as cardbus and express card. Others include network technologies, such as Ethernet. Others include IEEE 802.11 wireless connections such as WiFi and wireless USB and other Ultra-WideBand wireless technologies. The connection potentially includes IEEE 802.15 personal area networks including bluetooth or IEEE 802.16 wireless connections such as WiMAX. A source may connect using the Internet, intranet or extranet. Other valid connections include packet switching and cell switching networks, including frame relay, X.25 and Asynchronous Transfer Mode (ATM). Further, the connection 40 may be T-1, E-1, DS1, T-3, E-3, DS3, and the like and as may be used now or in the future.

It will be understood by those skilled in the art that the backup device 30 can be located internal or external to the source 20; thus, the backup device 30 could be a separate device from the source 20 or it could be an integral component or subcomponent of the source 20. Such backup device 30 includes any computing and data storage device that can store an executable computer program, has a data storage medium, and has input/output (I/O) capability for interfacing and interacting with the source 20.

As will be explained in greater detail hereinafter, the backup device 30 is configured to backup a pre-selected set of original data stored on the source 20, and, if necessary, restore such data back into the source 20 or to another source or storage device, if desired. Because of its configuration and programming, the backup device 30 provides an unprecedented ease of use for backup or restore of the data from the source 20, without requiring a user of the backup device to have specialized computer knowledge or capability and without requiring the user to install software or configure the system to identify files or folders to back up and without requiring the device to make a mirror image of all data and files on the source 20, which image would typically require far more storage space than a backup of data only.

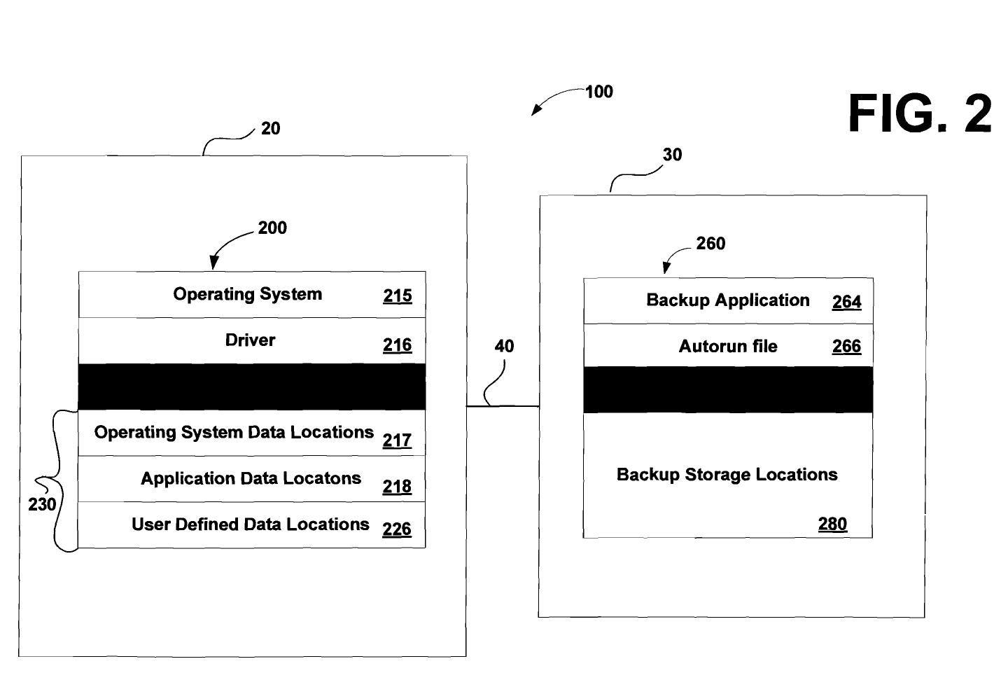

FIG. 2 illustrates a hardware/software level block diagram of the present system 100. For purpose of clarity, FIG. 2 does not represent all hardware, software, file, or folder components that are contained in the present system 100, but merely the file or file location components relevant to the present discussion. For example, conventional hardware components of the source 20, such as a motherboard and other related digital circuitry, are not shown. The source 20, in this example representing a Microsoft Windows XP-based computer, and the backup device 30 are shown in blown-up fashion to reveal some of the data and file structures stored therein.

For example, the source 20 includes a storage area 200 that includes, but is not limited to, a plurality of data storage locations 230, a driver 216, and an operating system 215. The operating system 215 manages the resources of the source 20. The operating system 215 may be any operating system, such Unix, Linux, Windows CE, Windows 95, Windows 98, Windows ME, Windows NT, Windows 2000, Windows XP, Windows Vista, and MacOS, including variants.

Generally, the source 20 is suitably configured with the driver 216 that is operative for establishing initial communication with any internal or external devices, and, in particular, the backup device 30. In the preferred embodiment, the driver 216 is a software program already installed and stored in the source 20 that allows the source 20 and its resources to communicate with the backup device 30. In alternative embodiments, the driver 216 can be obtained and installed directly from the backup device 30 or downloaded and installed from another device, source, or location (not shown).

Preferably, the operating system of the source 20 is configured with an “autorun” function enabled. The autorun function is a convenience feature that enables automatic launching of an executable file or application when a device containing the executable file or application is attached or connected to the source 20. In some cases, the operating system 215 may be protected, and hence, the source 20 may first require user permission to launch the executable file on the attached device. For example, in Windows Vista, administrative rights are typically needed to autorun some software located on an external hard drive. In such cases, a user with sufficient rights under the operating system 215 provides authorization for running the software by following a procedure prescribed by the operating system 215. Notably, after the autorun function has been authorized in Windows Vista for a particular application, such executable file will automatically launch thereafter without requiring another authorization.

The data storage locations 230 are depicted graphically and for simplicity in table format. Such file locations are those typically found and used in a Microsoft Windows XP operating environment. Similar, comparable file locations (not shown) exist for other operating systems and are intended to fall within the scope of the present invention. The data storage locations 230 contain, for example, files and folders associated with the following, general data storage locations in a Windows operating environment: Operating System Data 217 and Application Data 218. The data storage locations list 230 is not intended to be exhaustive and may contain other storage locations, including User Defined Data 226. The Application Data folder 218 represents a number of data storage locations that may be created by the operating system or may be created by individual applications to store data used in those applications. Application Data folder(s) are used by many applications, including Microsoft Outlook, Mozilla Firefox, Mozilla Thunderbird, Intuit QuickBooks, Peachtree Accounting, and many others. The User Defined Data 226 point to folders, subfolders, and files that are created by the source user. One example of a User Defined folder name under Windows XP would be c:\Projects.

Similarly, and still with reference to FIG. 2, the backup device 30 also contains its own data storage area 260 that includes, but is not limited to, a backup storage location 280, an executable version of the zero-configuration backup application 264, and an autorun file 266, such as the Windows file autorun.inf.

The zero-configuration backup application 264 and its functionality will be described in greater detail hereinafter. Briefly, it should be understood that the backup application 264 is designed to reside on, launch from, and run from the backup device 30, eliminating any hardware selection or software setup issues. The application 264 is configured to operate with the backup device 30 and, more particularly, enables a user of the source 20 and backup device 30 to back up and restore data easily between the two devices.

The application 264 may be programmed to provide a plurality of pre-configured versions. For example, versions may be created that embed options appropriate for ease of recovery, restricted access, high security, single-source, multiple-source, multiple-backup-device, multiple-operating-system, mobility of data, minimization of storage space used, and data synchronization models. Numerous other versions are also possible. In one embodiment, the embedded options may include the following: (1) backups are stored on a single associated backup device 30, (2) Windows data storage locations 217, several Application Data locations 218, and User Defined data locations 226 are backed up, (3) a full data backup is run of any source 20 by the backup device 30 and thereafter, an incremental backup is run, wherein all files that have changed since the last backup are copied to the backup device 30, (4) the backup device 30 stores all files in their native file formats, so that the copied versions are functionally identical to the originals, (5) the backup device 30 uses NTFS hardware compression to save space on NTFS-formatted backup device 30, (6) the backup executes upon connection to the source 20, and (7) the device 30 may be attached to and back up multiple sources 20. Optionally, backup device 30 may be configured to run at scheduled time intervals.

The autorun file 266 is designed to run the backup application 264 automatically. Generally, the autorun file 266 is specific to the operating system 215 on which the application 264 on the device 30, should be launched. If the autorun function is enabled on the source 20, the operating system 215 reads and carries out the specific instructions that the autorun file 266 defines. In such case, the operating system 215 automatically runs the backup application 264 that is pre-stored on the backup device 30.

The data storage locations 280 are defined by the particular implementation of the present system and method. In some cases, the data storage locations 280 may be a file system mirroring that on the source storage area 200. In other cases, the data storage locations 280 may be a single storage location into which all data is copied and which is indexed by an external database or other indexing system. Other configurations of the data storage locations 280 are also possible.

Although not shown, the source 20 and the backup device 30 each comprises one or more wired or wireless communication ports and a suitable connection mechanism 40, by which and through which data transfers between the source 20 and the backup device 30 occur.

As will be described hereinafter, the backup system 100 may be initiated by simply connecting the backup device 30 to the source 20 via the connection 40. The connection, when detected by the operating system 215, initiates the autorun sequence, which launches the backup application 264. In another embodiment, the backup application 264 may be executed by an external utility that initiates the application at scheduled times. Alternatively, a user may manually launch the backup application in a known manner.

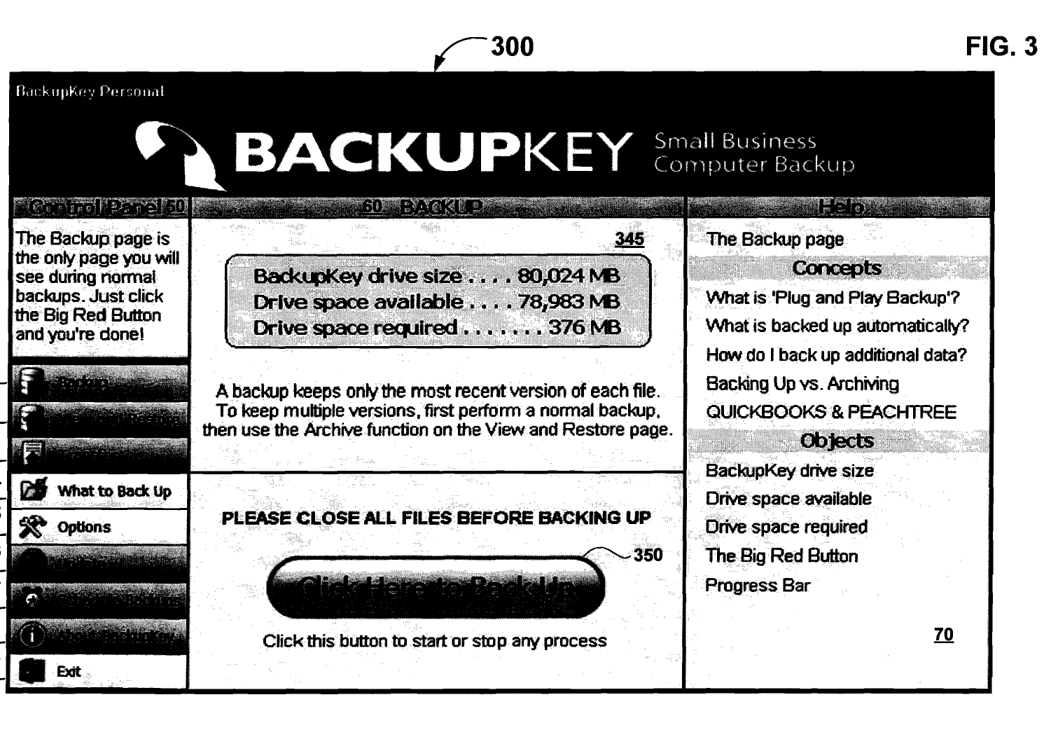

Although not required for the zero-configuration backup option, the backup application 264 does provide users with selectable or configurable options in situations in which the user does want to have some input or control over the back up or restore data options and user preferences of the present invention. The user preferences are implemented, if any have been selected, during the back up or restore processes. These aspects will be described in greater detail by reference to FIGS. 3 through 9.

FIGS. 3 through 9 illustrate various screen shots that are opened and displayed to the user on a suitable display of the source 20, when the backup application 264 has been launched from the backup device 30 connected to the source 20. Each screen shot is divided into five primary areas: a control panel area 50, a main information window 60 and a help area 70. As will be appreciated by those skilled in the art, the screen shots provided and described herein are exemplary only. These are provided merely to provide an enabling disclosure and are not intended to be limiting or to unduly narrow the scope of the methods and systems described herein.

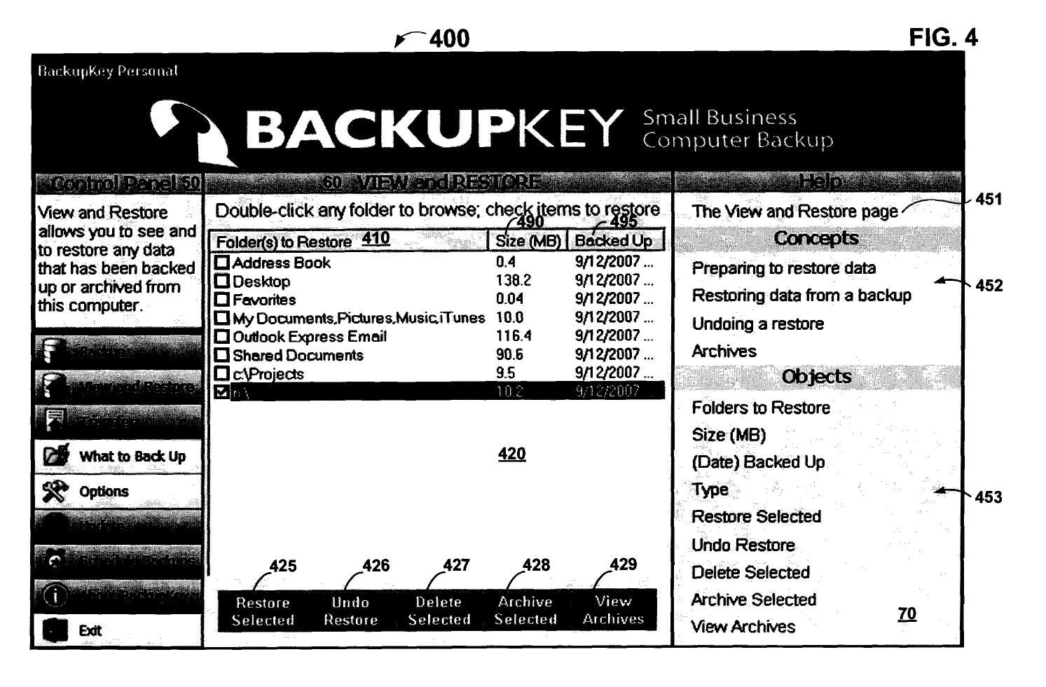

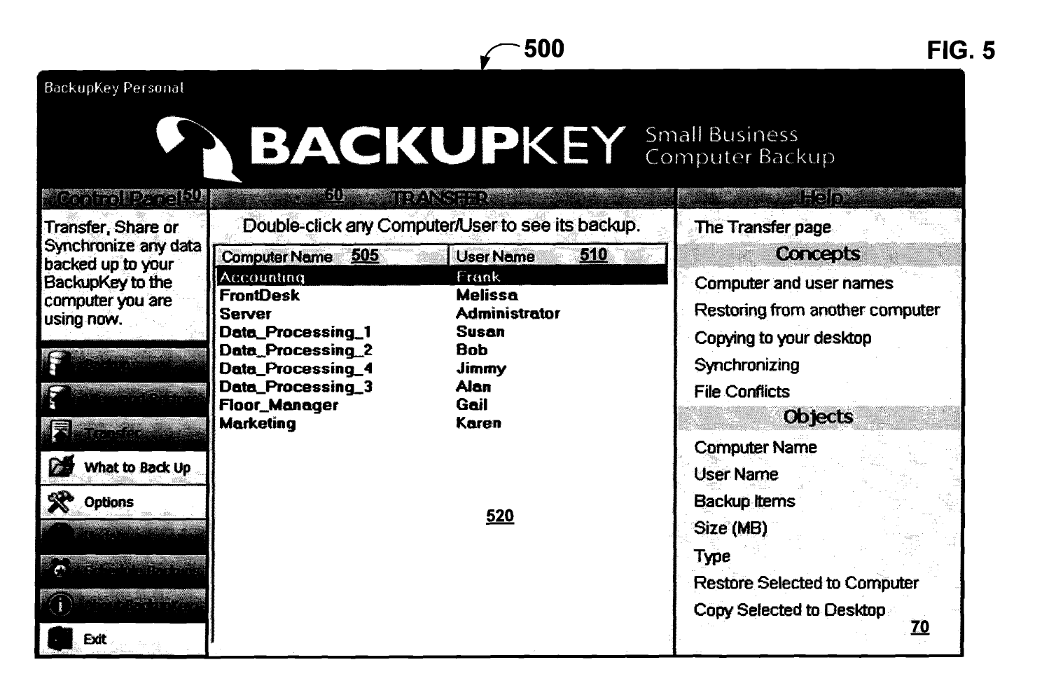

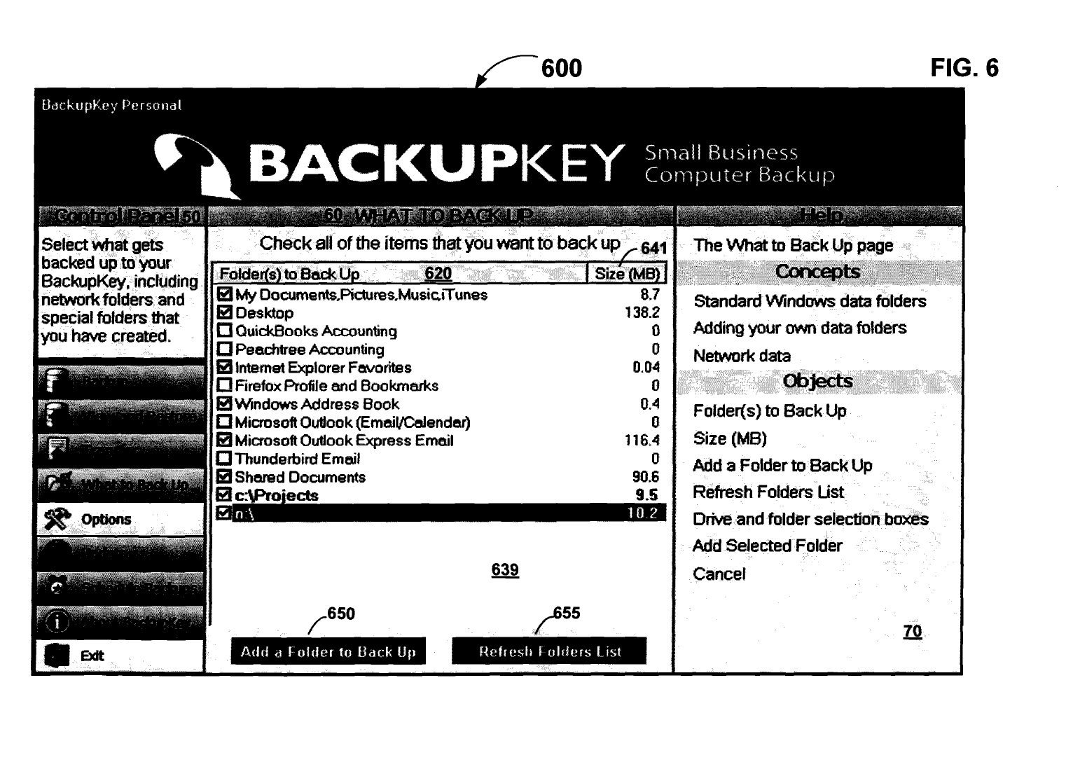

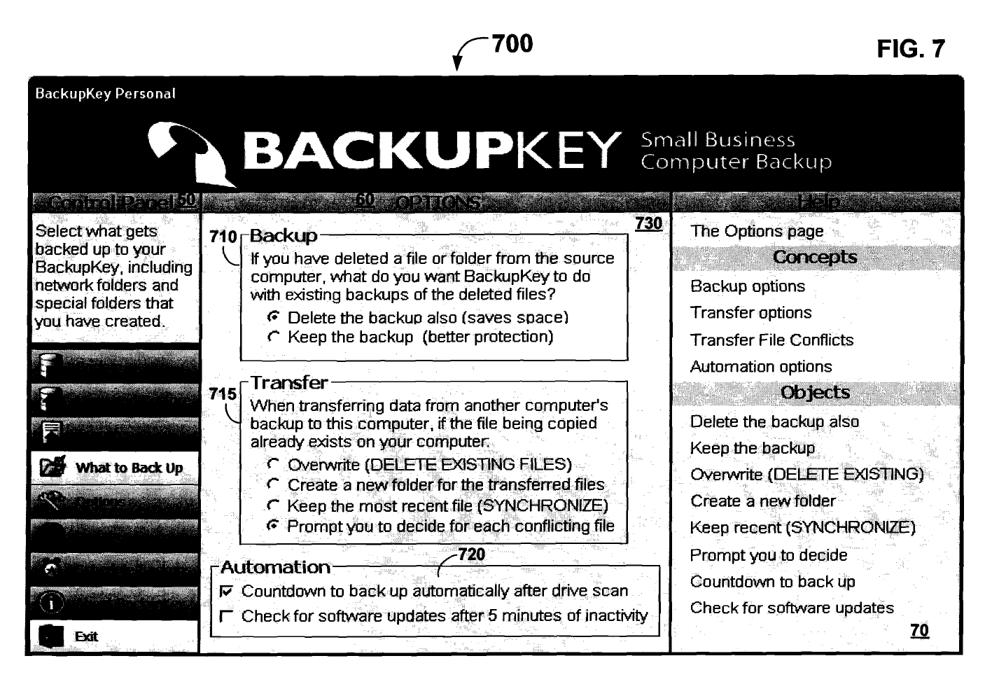

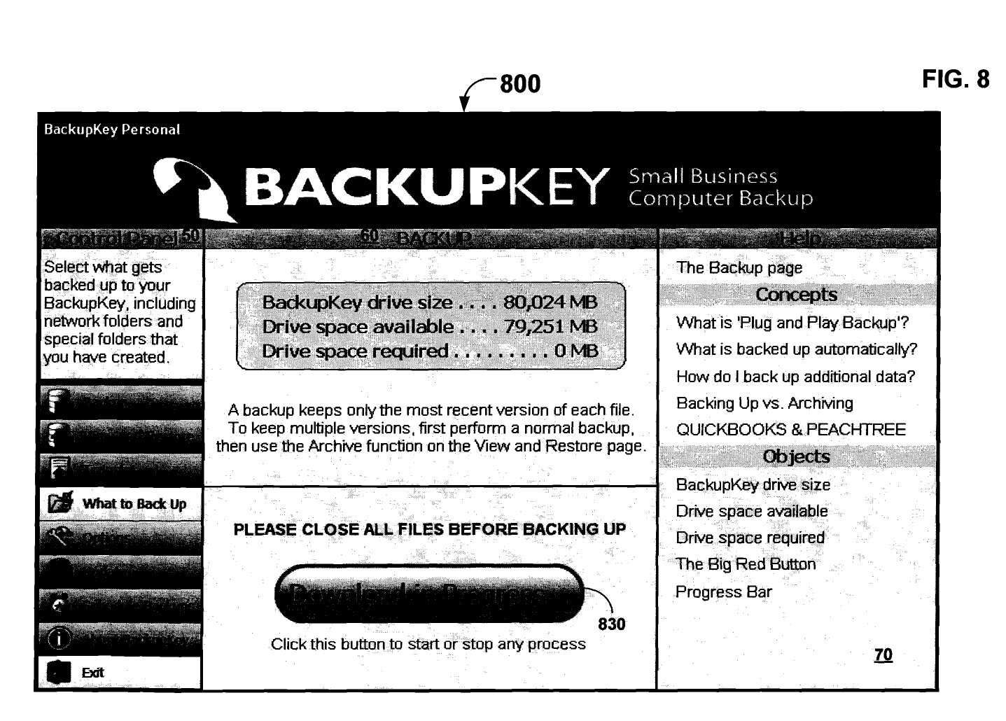

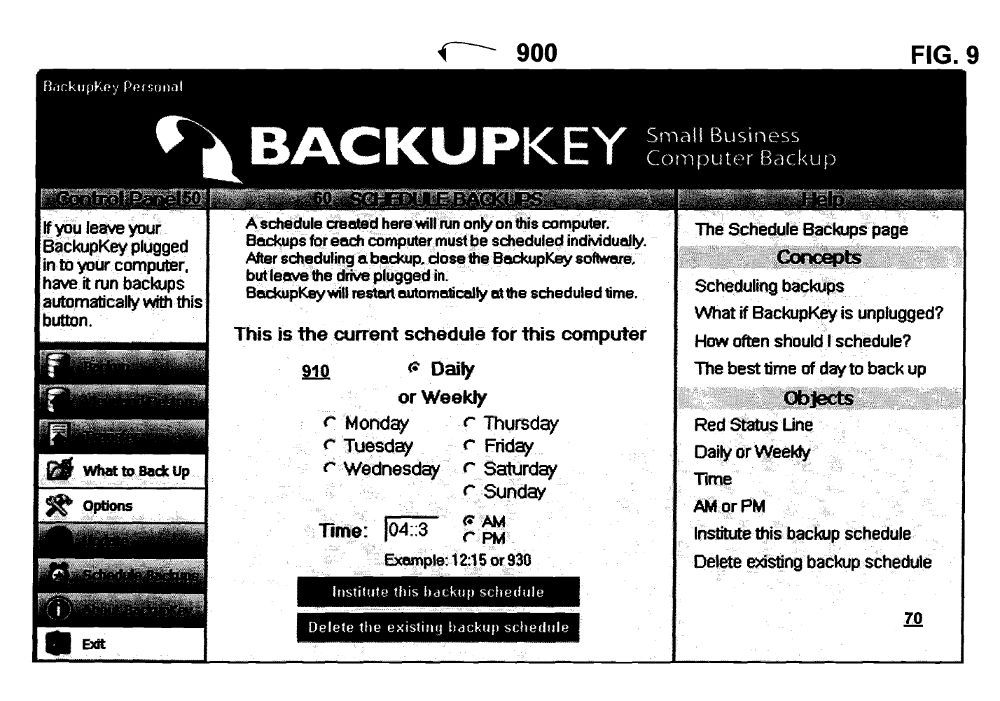

Specifically, FIG. 3 shows a Main Backup Page 300, FIG. 4 shows a View and Restore Page 400, FIG. 5 shows a Transfer Page 500, FIG. 6 shows a “What to Backup” Page 600, FIG. 7 shows an Options Page 700, FIG. 8 shows an Update Page 800, and FIG. 9 shows a Schedule Backup Page 900. The control panel area 50, shown on each screen shot, links to each respective page. Although it will be readily apparent to anyone familiar with using a computer or a Windows Operating System, the Backup button or icon 331 opens the Main Backup Page 300 of FIG. 3, the View and Restore button or icon 332 opens the View and Restore Page 400 of FIG. 4, the Transfer button or icon 333 opens the Transfer Page 500 of FIG. 5, the What to Backup button or icon opens the What to Backup Page 600 of FIG. 6, the Options button or icon 335 opens the Options Page 700 of FIG. 7, the Update button or icon 336 opens Update Page 800 of FIG. 8, and the Schedule Backups button or icon 337 opens the Schedule Backup Page 900 of FIG. 9. The About Backup button or icon 338 opens up a general information/contact/legal notice page (not shown). The Exit button or icon 339 exits the application 264. The help area 70 includes a number of buttons and linkable icons that, when selected, provide helpful information relevant to the operation of the application.

Turning back specifically to FIG. 3, the main window 60 of the Backup Page 300 includes an information window 345 that displays the drive size or total data storage capacity of the backup device 30, the drive space currently available, and the drive space that will be required to backup all of the files in the default (or user-modified) file and data locations on the source 20. In the lower part of the information window 345, a “start/stop backup” button 350 is provided, which, when clicked or selected by the user toggles the backup process between an “in progress” and “stop” state. An initial click initiates the actual backup process of the backup application 264. When a backup process is in progress, the “start/stop backup” button 350 can be used to stop the backup process at any time that it is running. Optionally and as stated previously, the application 264 can be configured automatically to start a backup process upon mere connection of the backup device 30 to the source 20. The backup device 30 automatically backs up files stored in the standard data storage locations 230, as previously described.

Turning now to FIG. 4, the main window 60 of the View and Restore Page 400 includes an information window 420 that displays data stored on the backup device 30 that has been previously backed up or archived from the source 20 to which it is attached. The data is displayed according to its primary data type or location 410, which corresponds to the file and folder locations of data stored on the backup device 30, as shown in FIG. 2. The display also indicates the folder location size 490 and the date 495 when the folder location was last backed up. The user merely needs to double-click one of the folder location names in column 410 to browse and restore specific subfolders and files within a folder location that has been backed up. Each folder location has a selection box, which enables the user to select one or more such folder locations for restoration back from the backup device 30 to the source 20. Buttons 425 enables the user to initiate a restoration of selected folder locations. Button 426 enables such restoration to be undone. Button 427 allows the user to delete specific folders or files from the backup device 30.

Button 428 allows the user to archive selected folder locations and button 429 allows such archived folder locations to be viewed. When being viewed, archived data is displayed by date of the archives Archiving copies an existing backup or selected portion of a backup to a date-specified storage location on the backup device 30 or on the source 20. When viewed, it is also possible to restore, undo, or delete such archived files in the same manner as normal backed up files.

Turning now to FIG. 5, the main window 60 of the Transfer Page 500 includes an information window 520 that lists any and all computer names 505 and associated user names 510 associated with data that has been previously stored on the backup device 30. Thus, it will be readily apparent to those skilled in the art that the backup device 30 of the present invention is capable of being used to backup and restore data from and among a plurality of different sources 20. The Transfer Page 500 enables a user to transfer, share or synchronize data stored on the backup device 30 to the source 20 to which the backup device 30 is currently connected.

Specifically, when a user double clicks any one of the computer names 505 or user names 510 in window 520, window 520 is updated to display folder locations, size, and backed up date similar to that shown in FIG. 4. The user is able to select desired folder locations for transfer to the corresponding file and folder locations on the currently-attached source 20 or merely to the desktop of the currently-attached source 20. The difference between a transfer and a synchronization, which is based on a selection on the Options Page 700 discussed hereinafter, is that a transfer automatically overwrites any corresponding file on the source 20 and a synchronization only overwrites any corresponding file if the backed up file has a more recent save date associated with it.

Turning now to FIG. 6, the main window 60 of the “What to Back Up” Page 600 includes an information window 639 that lists operating system data storage locations 217, application data storage locations 218, and user-defined data storage locations 226 on the source 20. This list corresponds to the file and folder locations shown in FIG. 2. The display also indicates the folder size 641 of each selected data storage location. Each folder location has a selection box, which enables the user to select or deselect folder locations that will be backed up during a standard backup procedure. Button 650 enables the user to add additional data locations for backup during routine backups. Button 655 enables the user to update the folder list after a new folder location, folder, or file has been selected or deselected by the user.

Turning now to FIG. 7, the main window 60 of the Options Page 700 includes an information window 730 that displays backup 710, transfer 715, and automation 720 options for controlling certain aspects of how the backup device 30 operates during a backup process. It will appreciated by those skilled in the art that the options shown in FIG. 7 are merely exemplary in nature. There are numerous additional or different options that can be included and would be included in different implementations of the present invention. For example, in some applications or uses of the present invention, it would be advantageous to be able to encrypt or compress data that is backed up. Numerous further options for type of encryption or compression and the like could also be included. As shown, however, in this embodiment, the backup option 705 includes two options: delete the backup (which saves space) or keep the backup (which provides better protection). Thus, if a user has deleted files or folders from the source 20, the “delete the backup” option will delete the corresponding file that had previously been backed upto the backup device 30. The “keep the backup” option will retain the backup on the backup device 30 even if the original data has been deleted from the source 20.

The transfer options 715 specify how the backup device 30 handles file conflicts during a transfer operation. The transfer options 715 include four possibilities: overwrite (which deletes existing files), create a new folder for the transferred files, keep the most recent files (i.e., synchronize, as previously described), and prompt if there is any file or folder conflict.

The automation options 720 specify to the backup device 30 whether to perform certain functions automatically. The automation options 720 include two separately selectable options. One option, “countdown to back up automatically after drive scan”, provides the user with a countdown of a certain amount of time, prior to a backup initiation, to interrupt the backup application upon the backup device 30 being connected to the source 20 or prior to a scheduled backup. The “check for software updates” option allows the backup device 30 to check for backup application software updates after a specified number of minutes of inactivity, wherein the backup device 30 scans the Internet for software updates, using the Internet access capabilities and protocols of the source 20 or, if suitably equipped to do so, using its own Internet access capabilities and protocols.

By selecting or clicking the Update button or icon 336, the user manually causes the backup application 264 to connect (or attempt to connect) to the Internet to search for an updated version of itself During this process, Update Page 800 of FIG. 8 is displayed and button 830 indicates the status of the update check and download. In an alternative embodiment, clicking the update button 336 can either cause the download of an update to occur in the background without changing the screen being viewed when the update button is selected, or the main Backup page 300 could be displayed.

Turning now to FIG. 9, the main window 60 of the Scheduled Backup Page 900 includes an information window 910 that enables a user to select a daily or weekly backup schedule that will cause the backup application to run backups automatically when the backup device 30 remains connected with the source 20.

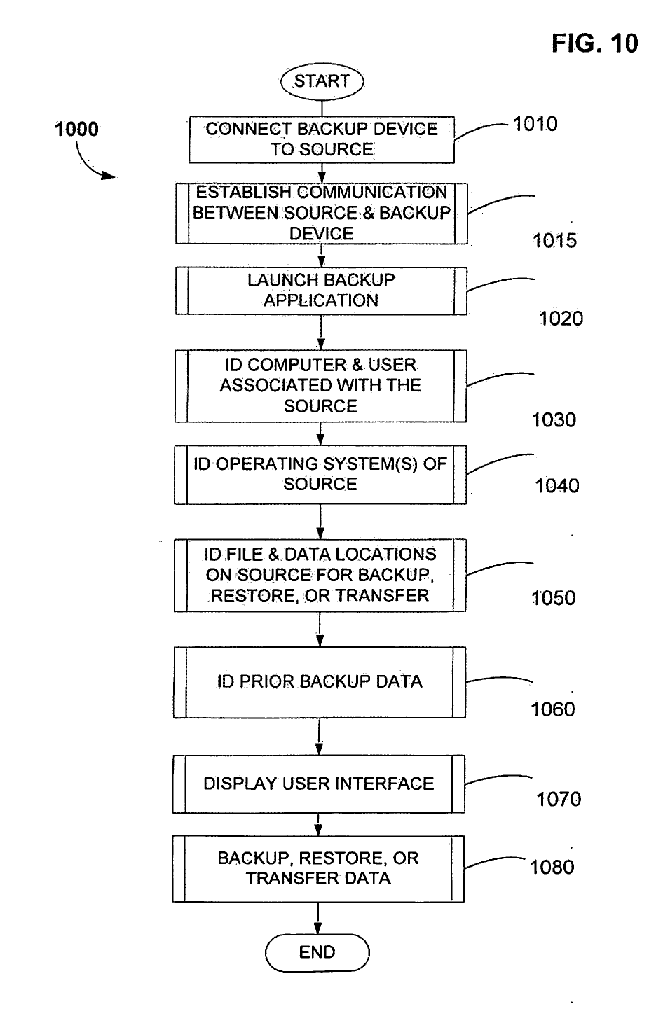

FIG. 10 illustrates a high level flow chart 1000 of the primary steps of an exemplary methodology of the present invention. The method 1000 first includes the step of connecting the backup device to a source that has data that needs to be backed up or that needs data restored thereon from the backup device using a wired or wireless connection (step 1010). An electronic communication must also be established between the backup device and the source (step 1015). Establishing an electronic communication typically requires use of a suitable driver software by the source to communicate with the backup drive. If a driver does not already exist on the source, it may be necessary to obtain and install it. Once the driver is installed, the source recognizes the backup device as a data drive and assigns it an identifier. Once connected, the backup application launches (step 1020). The launching of the application is preferably accomplished without any user intervention or requirements using an autorun capability integral to the source. If necessary, for example if the source has security settings that prevent autorun, if autorun has been disabled, or if the source does not include an autorun capability, the user can manually launch the backup application in a conventional manner. Next, in preferred embodiments, since the backup device may be advantageously configured to be usable with multiple sources and multiple users, the backup application identifies the specific computer and user associated with the source to which the backup device has been connected (step 1030). If the backup device, in other embodiments, is configured for use solely with one source and/or one user, this step may be omitted. Next, the backup application identifies the operating system or systems associated with the source to which it is attached (step 1040). This step may be unnecessary in some cases, for example, once the backup device has been configured with a particular source. Alternatively, it may be desirable to perform this step every time just to confirm, that in rare situations, a new operating system has not been installed or introduced to a particular source. Based on the source operating system, the backup application identifies the default data locations associated with the operating system and common applications (step 1050). In the absence of user intervention or configuration, which is not required for operation of the backup device or backup application, these identified data locations will be the ones that will be backed up by default. The backup application, however, checks for user preferences as part of this step to determine if additional user-defined or user-identified data locations have been specified for backup. Conversely, the backup application also determines whether the user has unselected or deselected any default file or data locations that the user has chosen not to backup. Next, the backup application determines if there has been any data backed up previously from the identified data locations (step 1060). Pre-configured rules or user-defined rules for handling file conflicts will determine the disposition of data files when previous backups exist. Similar default and user-defined rules may be used to determine how files with name conflicts will be handled on a restoration or file transfer. In most cases, it is preferred that the more recent version of a file that exists on both the source and the backup device will be backed up. A user interface is preferably displayed to the user on a display device (step 1070). Most typically, the display device is associated with the source; however, in some embodiments, such display device will be associated with the backup device. This type of configuration is desirable for use with sources that stored data or information but that do not have any or do not have a significant display capability. The user interface provides much greater capability to the backup device because, for example, it enables the user to select whether he wants to backup, restore, or transfer data to or from the source or backup device. It also enables the user to customize or configure the backup application if desired. It also enables the user to interrupt a backup, transfer, or restoration in process. It also enables the user to view and select files, folders, or other data locations on either the source or the backup device. Further, the user interface allows the user to specify other options, such as whether backup files and data will be encrypted or compressed as part of the backup process. By default and if used in zero configuration mode, the user interface is not necessary for the pure or initial backup functions performed by the backup device, which is designed to run upon connection of the backup device to the source. Finally, the backup device performs its default or user-selected action of backing up data from the source to the backup device, restoring data from the backup device to the source, or transferring data stored on the backup device but associated with a different source or user to the source to which the backup device is currently connected (step 1080).

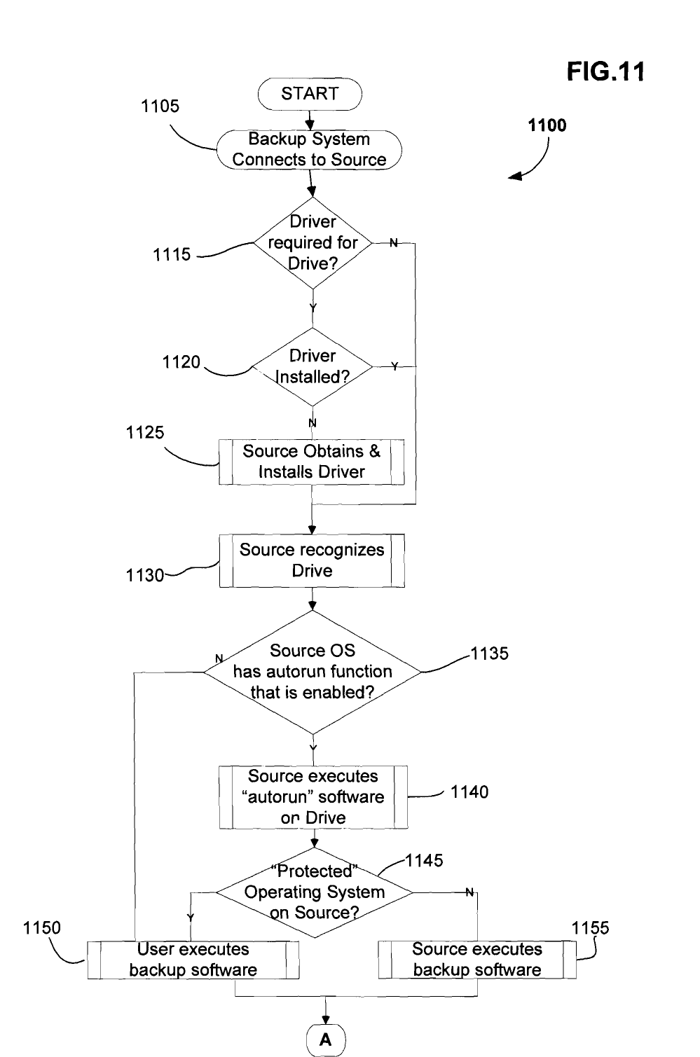

FIG. 11 illustrates a logic flow diagram 1100 describing the initial steps performed by the present system for launching the backup application in a first preferred embodiment. Initially, the backup device 30 is connected to the source 20 (step 1110). The system checks whether the source can execute the backup application stored on the backup device. It does this by first checking (step 1115) whether driver software is required for communicating with the backup device. If a driver is not required, then the source recognizes the backup device and assigns an identifier to the backup device (step 1130). If a driver is required, then a determination is made as to whether the driver is already installed on the source (step 1120). If a suitable driver is already installed, then the source recognizes the drive and assigns an identifier to the backup device (step 1130). If the required driver is not installed, then the source obtains and installs a suitable driver either from the backup device or from another location (e.g., from disc, website download, etc.) (step 1125). The source recognizes the drive and assigns an identifier to the backup device (step 1130).

Next, a determination is made as to whether the source's operating system has autorun enabled (step 1135). If autorun is not installed or enabled on the source, the user must manually launch the backup application (step 1150). If autorun is installed and enabled on the source, the source finds the autorun file that resides on the backup device and executes the autorun file (step 1140). A determination is then made as to whether the operating system is protected or needs administrative permission (step 1145). If the operating system is protected or needs administrative permission, then user must manually launch the backup application or grant the operating system permission to run the application (step 1150). If the operating system is not protected or does not need administrative permission, then the source launches the backup application from the backup device (step 1155). The backup application is now in “running” mode.

As a side note, some operating systems may not allow external devices to run programs without explicit user permission. For example, in Windows Vista, the operating system may be protected and may enable the autorun functionality if the user or administrator has selected “Run as Administrator”. After permission has been granted during the initial execution, the backup application will run automatically each subsequent time the backup system is connected to the source. Generally, an operating system, for example, Windows 2000 and XP, is suitably configured with the autorun function enabled.

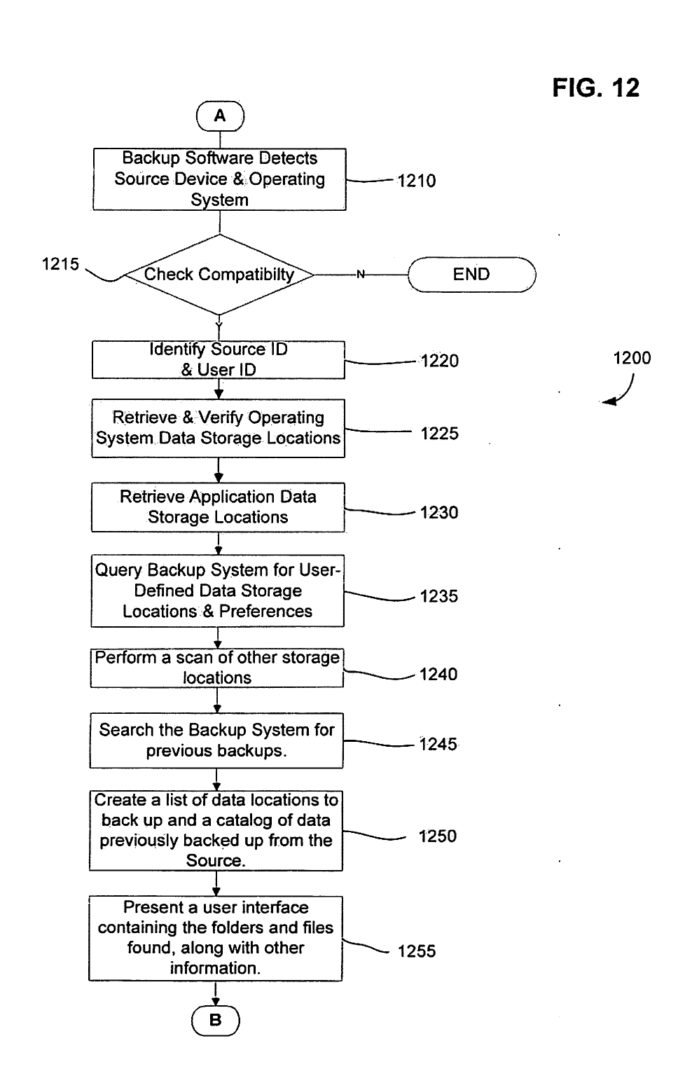

FIG. 12 illustrates a logic flow diagram 1200 describing the initialization steps performed by the backup application after it has been successfully launched. This process picks up where FIG. 11 left off. First, the backup application detects the source and the operating system (step 1210). Next, a determination is made as to whether the source and operation system are compatible with the backup device and backup application (step 1215). If the answer is no, the application closes.

If the source and operating system are compatible in step 1215, then the backup application detects a source and user identifier (if applicable) associated with the source (step 1220). This step 1220 is necessary in situations in which the backup device is used with more than one source or more than one user on a single source. Based on the identification of the operating system, such as Windows XP, the backup application retrieves its pre-configured or internal catalog of standard data locations associated with such operating system (step 1225). Preferably, the backup device is configured for use with all operating systems relevant to the particular implementation and maintains a catalog of standard data locations associated with sources using each such operating system. Alternatively, backup devices can be uniquely configured to work with specified operating systems and such compatibility will be identified on packaging of the backup device when sold. For example, and as shown in FIG. 2 for illustrative purposes only, Windows XP typically uses the following standard user data storage locations: My Documents, Desktop, Internet Explorer Favorites, Windows Address Book, Outlook Express, and Shared Documents. Other locations also may be used in specific situations. The backup application then verifies the actual file system locations (file paths) of these data locations. For example, “My Documents” folder may have been previously moved by the user from its default file system location to another location. Windows and most operating systems maintain an index of the file system locations for their primary data storage locations.

Next, the application data storage locations are retrieved from the source (step 1230). Again, the backup device may be pre-programmed or pre-configured with common application data storage locations applicable to the operating systems with which the backup device has been designed to be compatible. For example, Windows allows installed applications such as Microsoft Outlook or Mozilla Firefox to create additional data storage locations associated with such applications. The backup device preferably is configured with the default data storage applications for well-known and popular applications. Such applications include, for example, Microsoft Outlook, Mozilla Firefox, Mozilla Thunderbird, Intuit QuickBooks, and Peachtree Accounting.

Next, the backup application determines if the user has previously identified user-defined files, folders, or data locations (if supported by the source) (step 1235). As previously discussed in association with the above screen shots, with some types of sources, such as a computer, a user is able to specify user-defined files, folders, or data locations for backup, restoration, or transfer purposes.

Next, the backup device scans other storage locations in the device to find data in other locations that may require backing up (step 1240). The additional storage locations may include such items as Windows Registry, user settings, login data, application templates, network and connection information, among others. Then the backup application determines if there have been any previous backups for this source and user that have been stored on the backup device (step 1245). Next, the backup application generates a list of files, folders, and other file or data storage locations on the source (available for backup) and, in some implementations, a catalog of data previously backed up to the backup device (available for restoration, transfer, and archival) (step 1250). Finally, the backup application presents the user with a user interface for interacting with the backup application, including review and examination of the list of files, folders, and other file or data storage locations on the source (available for backup) and on the backup device (available for restoration, transfer, and archival) among other things.

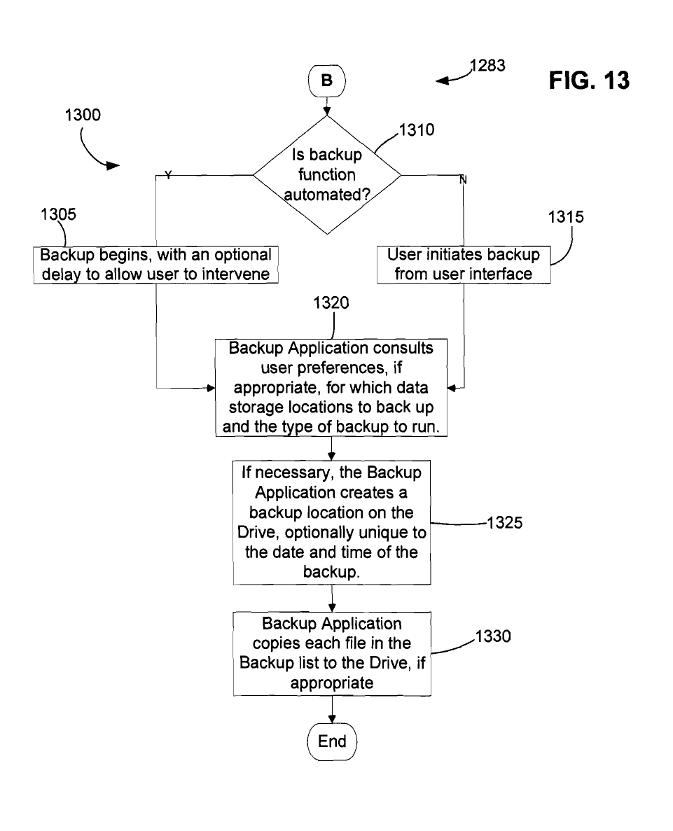

Turning now to FIG. 13, an automated or manual backup process 1300 using the present system is disclosed. First, the backup application determines whether the backup function has been automated (step 1310). Preferably, such backup application function is initially configured on the backup device to run in an automated fashion or is configured to run at a schedule interval (step 1305). Optionally, a countdown or delay may be presented to the user through the user interface to enable the user to halt the automated backup before it runs. If the backup has not been automated to run upon connection of the backup device or at a scheduled time or if the user merely wants to run the backup process manually, the user is able to initiate the backup process as previously described in association with the above screen shots (step 1315). When the backup process starts, the backup application determines which file and data locations have been selected (by default or by user intervention) (step 1320). If necessary, the backup application creates a backup location on the backup device, optionally unique to the date and time of the backup or the particular device being backed up (step 1325). Finally, if appropriate or as designated by default options or user-defined options, the backup application copies each file (or subset of data) in the backup list to the backup device, using either a duplicate file structure or a lookup system to determine each file's location (step 1330). Such files may optionally be encrypted, compressed, combined into a single file, or split so that each file or the entire data set is stored on multiple backup drives, such as a Redundant Array of Independent Disks (RAID) configuration. Such options can be pre-configured into a particular backup device design or they may be modified by user preference. As described previously, using the user interface, the user is able to select and move files from the backup device to the source in a restore mode, transfer mode, or synchronization mode.

An alternative embodiment, not shown but similar to FIG. 11, and for use with a non-PC-computer-type source, such as a camera, media player, telephone, and personal digital assistants, among others, causes the backup device, if compatible with the source, to automatically run the backup process for all conventional file locations of the source.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

I claim:

1. A method of backing up data stored on a source, comprising the steps of:
connecting a backup device to the source, the backup device having a backup application stored therein;
launching the backup application from the backup device without user installation of the backup application;
identifying the operating system and data storage structure of the source to the backup application;
retrieving a pre-configured list associated with the identified operating system and data storage structure wherein the pre-configured list identifies data storage locations for data stored on the source; and
copying data from the identified data storage locations on the source to pre-defined data storage locations on the backup device.

2. The method of claim 1 wherein the step of copying data includes implementing pre-defined options programmed into the backup application.

3. The method of claim 2 wherein the pre-defined options include one or more of data compression, data encryption, data overwrite, data synchronization, and scheduled time for initiating the step of copying.

4. The method of claim 1 further comprising obtaining user authorization before the step of launching the backup application.

5. The method of claim 1 wherein the step of copying data includes implementing user-defined options selected by a user of the source and wherein the user-defined options are stored on the backup device.

6. The method of claim 1 wherein the pre-defined data locations on the backup device mirror the identified data storage locations on the source.

7. The method of claim 1 wherein the pre-defined data locations on the backup device include a single storage location that is indexed according to the pre-defined data locations on the backup device.

8. The method of claim 1 wherein the backup device stores data in a Redundant Array of Independent Disks (RAID) configuration.

9. The method of claim 1 further comprising the step of displaying a user interface to a user of the source and wherein the user interface is displayed on a display associated with the source or associated with the backup device.

10. The method of claim 1 further comprising the step of enabling a user of the source to identify user-defined data storage locations on the source and wherein the step of copying further comprises copying data from the user-defined data storage locations on the source to the backup device.

11. The method of claim 1 further comprising the step of restoring previously copied data back from the backup device to the identified data storage locations on the source.

12. The method of claim 1 further comprising the step of transferring previously copied data from the backup device to the identified data storage locations on a different source.

13. The method of claim 1 wherein the backup device is configured for use with a plurality of sources and users and further comprising the step of identifying the source and user of the source after connecting the backup device to the source.

14. The method of claim 1 wherein the source is one of a computer, a server, a PDA, an external computer drive, a portable data collector, a handheld data storage device, a phone, a camera, a global positioning system device, a formatted media player, an embedded data storage device in another machine or another device.

15. The method of claim 1 further comprising the step of encrypting, compressing or otherwise changing the nature of the data copied to the backup device.

16. The method of claim 1 wherein the backup device is connected to the source using a wired or a wireless connection.

17. The method of claim 1 wherein the step of launching the backup application is accomplished using autorun functionality associated with the operating system of the source when the backup device is connected to the source.

18. The method of claim 1 wherein the step of launching the backup application is accomplished by the operating system of the source after receiving approval from a user of the source.

19. The method of claim 1 wherein the backup application is launched manually by a user of the source.

20. The method of claim 1 wherein the backup application is launched automatically and periodically according to a backup schedule.

21. The method of claim 1 wherein the pre-configured list is retrieved by the backup application from a database on the backup device.

22. The method of claim 1 wherein the pre-configured list is retrieved by the backup application from a database accessed through the source.

23. The method of claim 1 wherein the pre-configured list is retrieved by the backup application from a database accessed over the Internet.

24. A method of restoring data to a source, comprising the steps of:
connecting a backup device to the source, the backup device having a backup application stored therein;
launching and running the backup application from the backup device without user installation of the backup application;
identifying data on the backup device associated with a previous backup of data from data storage locations on the source;
displaying a user interface to a user of the source, wherein the user interface is adapted to display the identified data stored on the backup device; and
copying selected data from the identified data stored on the backup device to the corresponding data storage locations on the source.

25. The method of claim 23 wherein the display of the identified data is presented in a collapsible, hierarchical file and folder format.

26. The method of claim 23 further comprising the step of prompting the user before the copying of selected data if there is a filename conflict between data being stored on the backup device and the source.

27. The method of claim 23 wherein the step of identifying data on the backup device comprises identifying data associated with more than one previous backup of data on the backup device and wherein the step of displaying displays more than one previous backup to the user.

28. The method of claim 23 wherein the step of copying selected data comprises enabling the user to select from between at least two different sets of data previously stored on the backup device.

29. A method of transferring data from a first source to a second source, comprising the steps of:
connecting a backup device to the first source, the backup device having a backup application stored therein;
launching the backup application from the backup device without user installation of the backup application on the first source;
identifying the operating system and data storage structure of the first source to the backup application;
retrieving a pre-configured list associated with the identified operating system and data storage structure of the first source wherein the pre-configured list identifies data storage locations for data stored on the first source;
copying data from the identified data storage locations on the first source to the backup device; and
thereafter:
connecting the backup device to the second source;
launching the backup application from the backup device without user installation of the backup application on the second source;
displaying a user interface to a user of the second source, wherein the user interface is adapted to display a listing of data copied to the backup device from the first source; and
selectively copying data identified in the listing of data to corresponding data storage locations on the second source.

30. The method of claim 29 further comprising the step of identifying the operating system of the second source to the backup application after connecting the backup device to the second source.

31. The method of claim 30 further comprising the step of identifying data storage locations on the second source associated with the operating system of the second source.

32. The method of claim 30, wherein the operating system of the second source differs from the operating system of the first source, and further comprising the step of using a pre-programmed data map to determine the data storage locations on the second source that correspond with the data storage locations of the first source.

33. The method of claim 29 wherein the step of selectively copying data to selected data storage locations on the second source comprises overwriting data previously stored on the second source.

34. The method of claim 29 wherein the step of selectively copying data to selected data storage locations on the second source comprises, if there is a filename conflict between data being copied to the second source and data pre-existing on the second source, creating a new storage location on the second source for receiving the data being copied.

35. The method of claim 29 wherein the step of selectively copying data to selected data storage locations on the second source comprises, if there is a filename conflict between data being copied to the second source and data pre-existing on the second source, overwriting data previously stored on the second source only if the data being copied from the backup device has a more recent file date.

36. The method of claim 29 wherein the step of selectively copying data to selected data storage locations on the second source comprises, if there is a filename conflict between data being copied to the second source and data pre-existing on the second source, prompting a user of the second source to decide whether to overwrite data previously stored on the second source.
